(19) United States
(12) Patent Application Publication
(10) Pub. No.: US 2023/0042617 A1
(43) Pub. Date: Feb. 9, 2023

(54) METHOD AND SYSTEM FOR COMPSENSATING A DATA SELLER FOR DATA USED IN A DATA AND ANALYSES SYSTEM

(71) Applicant: Webster Hughes, Pineville, NC (US)

(72) Inventor: Webster Hughes, Pineville, NC (US)

(21) Appl. No.: 17/859,205

(22) Filed: Jul. 7, 2022

Related U.S. Application Data
(60) Provisional application No. 63/289,882, filed on Dec. 15, 2021.
(60) Provisional application No. 63/284,106, filed on Nov. 30, 2021.
(60) Provisional application No. 63/223,447, filed on Jul. 19, 2021.
(60) Provisional application No. 63/250,701, filed on Sep. 30, 2021.

(51) Int. Cl. G06Q 20/38; G06Q 40/04; G06Q 30/04

(52) U.S. Cl. CPC G06Q 20/3825; G06Q 40/04; G06Q 30/04; G06Q 2220/00

(57) ABSTRACT

A system and method including receiving input data from a plurality of Data Sellers, selling tokens to a plurality of Data Buyers, receiving tokens from a first Data Buyer in exchange for providing data and analyses calculated from input data received from one or more Data Sellers, paying tokens to the each Data Seller whose data was used to calculate the data and analyses provided to the first Data Buyer, and trading tokens between token buyers and token sellers.

Applicants hereby claim the benefit of the following provisional patent applications, Provisional Patent No. 63/289,882 filed Dec. 15, 2021, entitled “Method and System to Provide a Software System for the Valuation and Underwriting of Metaverse Real Estate,” Provisional Patent No. 63/284,106 filed Nov. 30, 2021, entitled “Method and System to Create a Cryptocurrency Backed by Specific Types of Data which is Bought and Sold by Holders of the Cryptocurrency,” Provisional Patent No. 63/223,447 filed Sep. 30, 2021, entitled “Method and System to Use Transferable Invoices to Finance the Buying and Selling of Data Tokens,” and Provisional Patent No. 63/250,701 filed Jul. 18, 2021, “Method and System to Collect, Purchase, and Calculate Data and Sell, Grant, Transfer, and Exchange Tokens for Data,” each of which is hereby incorporated by reference in its entirety into this application.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

The present invention disclosed herein relates generally to computerized data and analyses systems using data provided by one or more parties to perform analyses that users of the system pay fees to view and download. More particularly, the present invention relates to a computerized system (henceforth called “the system”) whereby a system user (henceforth called “user or “Data Buyer”) may analyze a real estate property (henceforth called “Data Buyer property” or “subject property”) by comparing of data on the subject property to data on a set of comparable properties (henceforth called “database properties” or “comparable properties” or “comps”) where the data

from the set of comparable properties is provided by one or more other parties (henceforth called “Data Sellers”) and stored on a data table.

### BACKGROUND

The use of data and analyses systems has increased dramatically in recent years. These systems generally perform the following service: 1) collect and purchase data relating to specified items and subject matter; 2) store the collected and purchased data on computer database tables; 3) perform calculations related to the collected and purchased data stored on computer database tables; 4) store the calculations on the same and other computer database tables; 5) provide computer programs which enable users to view or download designated subsets of the collected, purchased, and calculated data; 6) charge fees to users of the computer programs and the data service.

Companies that provide data and analyses systems use a variety of payment schemes to charge fees paid by users of the data systems. These schemes may include (but are not limited to): 1) periodic subscription fees; 2) one-time data transfer fees; 3) selling ads to companies who want to advertise to users of the computer programs and data service.

### SUMMARY OF THE INVENTION

The Claimed Invention is a method and system for performing the steps required to provide the data and analyses service, for the implementing payment schemes to charge fees to users of the data service, and for compensating providers of data that the system uses to generate the data and analyses that users pay for. Specifically, the Claimed Invention uses a token system for the data purchase steps, for the charging the users for the service, and for compensating Data Sellers. This simplifies accounting and provides an ecosystem where the tokens can be exchanged for tangible value either in the form of data, currency, or services.

An embodiment of the Claimed Invention is applied specifically to collecting and purchasing data related to real estate assets and performing calculations related to the valuations and operating performance of those real estate assets. This embodiment of the Claimed Invention utilizes a token payment system whereby: 1) Users of the system purchase tokens from the Operator of the system (henceforth called “System Operator”) in exchange for agreeing to pay an outstanding invoice (henceforth called “invoice”); 2) Users of the system use those purchased tokens to purchase data and analyses sold on the system; 3) Data Sellers receive tokens in exchange for providing data which is used for analyses and sold on the system; 4) The amount of tokens received by the Data Seller is determined by the amount of tokens paid for data and analyses which use data provided by the date provider; 5) the tokens may be transferred, bought, and sold to and from system users and Data Sellers; 6) the buying and selling of tokens may be executed either by exchanging cash or offsetting token invoice balances.

The present invention provides a system and method including receiving input data from a plurality of Data Sellers, selling tokens to a plurality of Data Buyers, receiving tokens from a first Data Buyer in exchange for providing data and analyses calculated from input data received from one or more Data Sellers, paying tokens to the each Data Seller whose data was used to calculate the data and analyses provided to the first Data Buyer, and trading tokens between token buyers and token sellers

### DETAILED DESCRIPTION OF THE INVENTION

Data and Analyses System:

The Embodiment of the Claimed Invention is a computerized system (henceforth called “the system”) whereby a system user (henceforth called “user or “Data Buyer”) may analyze a multifamily property (henceforth called “Data Buyer property” or “subject property”) by comparing of data on the subject property to data on properties selected from a database of other properties (henceforth called “comparable properties” or “comps”). The database of comparable properties (henceforth called the “comps database”) is comprised of data extracted from documents which may be provided by the owner of the database properties, collected by third parties, or some combination thereof. In this configuration, each individual comp is represented and defined by values of specified data fields stored on a data table with a unique property identifier (henceforth called “property id”).

Comparative Analyses:

Comparisons between the subject properties and the comparable properties (henceforth called “comparative analyses” or simply “analyses”) may be configured as line-item data comparisons to individually selected comps (henceforth called “comp set”) or as a comparison to statistical measurements calculated from a broader set of comps (henceforth called “observation set”). Individual comps and comp sets used for the comparative analyses may be selected either by the Data Buyer or by system algorithms. In both cases, the comps are typically selected so as to have similar values for specified data line-items. For multifamily properties these line-items typically include location, demographics (in the current implementation represented by tract-level census data), number of units, year built, year renovated, property subtype (Garden-Style, Mid-Rise, High-Rise, Senior, Student, etc.), and recent property operating data. The recent operating data may include occupancy, revenue, expenses, year-on-year changes in these values, and specific expense line-items such as taxes, insurance, repairs, payroll, etc.

Comp Selection Algorithms:

An important component and feature of the system is the process by which system algorithms select comps, comp sets, and observation sets to use for calculating analyses. An important component and feature of algorithms used to select observation sets includes segmenting the comps database into groupings defined by the ranges of values for the above-mentioned data fields. Another important component and feature of the algorithm used to select observation sets includes segmentation of the database into groupings of properties defined by which of the various above-mentioned data fields are populated and which are missing (i.e., “null”). The presence of null values for data fields in an observation set restricts the statistical calculations which may be performed using the given observation set. An important component and feature of the algorithm used to select observation sets is determining which statistical calculations to perform depending on which data fields do and do not have null values. This means that a property with no null values in specified data fields may be included in an observation set for which a more refined statistical calculation may be performed whereas a property with null values in those same specified data fields may not be included in an observation set for which a more refined statistical calculation may be performed. An important component and feature of the algorithm used to select observation sets is determining whether to select larger observation sets with more null values and less refined statistical calculations or smaller observations with less null values and more refined statistical calculations. The comp set and observation set selection algorithms are performed when Data Buyers use the system to analyze Data Buyer properties.

Recording Comps Used for Comparative Analyses

Another important component and feature of the system is the tracking and recording of property ids of comps used for comparative analyses and/or included in observation sets selected by algorithms when Data Buyers use the system to analyze a Data Buyer property. For observation sets, this recording is implemented by recording the ranges of data fields and specification of null values which a comp must satisfy to be included in the given observation set (henceforth called “observation set criteria”). This feature of recording selected comp property ids and observation set criteria improves transparency and enables the Data Buyer to better understand the results of the analyses and to reproduce the same analysis at a future time. It also provides a mechanism whereby the system tracks the number of times that any individual database property is used for the various types of Data Buyer property analyses generated by the system. Each usage of data provided by a Data Seller to calculate data and analyses that are purchased by a Data Buyer is stored on the COMPBANK database table.

Comp Credits Payment Model:

Another important component and feature of the system is the payment model which is used to charge Data Buyers for analyses performed by the system. The payment model is based on digital tokens which the system operated sells to Data Buyers and then accepts as payment from Data Buyers for performing the various analyses discussed above. For the present invention, the tokens are called “Comp Credits” and each of the analyses discussed above are priced in as numbers of credits. Each purchase of Comp Credits and each instance of using Comp Credits to purchase data and analyses is recorded on the COMPBANK database table.

An extract from the Multifamily Comps LLC (“MFC”) User Guide is show below.

Extract from MFC User Guide:

“The most basic MFC product is a 1-year subscription to monthly updated data for a Comparable Property (Comp) selected from the MFC database. MFC uses pre-purchased Comp Credits as the currency for STATVAL™ data and analyses. Data Buyers may pre-purchase Comp Credits and are invoiced monthly. This payment system means that Data Buyers may utilize STATVAL™ as much or as little as desired with no minimum payment obligation.”

Table 1 below is a price schedule extracted the STATVAL™ user guide:

TABLE 1
1-Year Subscriptions with Monthly Data Updates and Statistics

| | |
|---|---|
| Line-Item Property Data | 1 Comp Credit per Comparable Property |
| (Unmasked Comp) | |
| Operating Statement | 5 Comp Credits Per Client Property |
| Benchmark Analysis | |
| Statistical Valuation and | 5 Comp Credits Per Client Property |
| Underwriting | |
| Geography/Subtype | Select Geography/Subtype (e.g., South/Garden) |
| Research Download | .2 Comp Credits per Database Property |
| CMBS Loan-Level | Select CMBS Deal Name (e.g., K-F29) |
| Surveillance Download | .2 Comp Credits per Outstanding Loan |

The COMPBANK table records each Data Buyer purchase of Comp Credits, each Data Buyer usage of Comp Credits to pay for data and analyses, and each usage of data provided by a Data Seller to calculate data and analyses that is sold to a Data Buyer.

Compensating Data Sellers:

Recording on the COMPBANK database table of the Comp Credits purchases, Comp Credits usage to purchase data and analyses, and usage of data provided by Data Sellers to calculate purchased data and analyses provides a formula for compensating a Data Seller based on the number of times that the Data Seller's data is used for Data Buyer data and analyses. The purpose of the compensation formula is to pay the Data Seller a prorated percentage of the number of Comp Credits which Data Buyers pay the System Operator for data and analyses that the Data Seller's data is used to calculate. For a given Data Buyer analysis and given Data Seller, the prorated percentage equals the number of the times the given provider's data is used divided by the total number of times all providers' data is used for the given analysis. For example, if the given analysis is a Operating Statement Benchmark Analysis against a Comp Set comprised of 10 comps, and 2 of those 10 comps are provided by the given Data Seller, then the prorated percentage would be 20%. If, as in Table 1 above, the price of the Operating Statement Benchmark Analysis is 5 Comp Credits, the compensation formula would be a fractional share of 5 Comp Credits x 20%=1 Comp Credit. The fractional share is a negotiated amount between the system provider and Data Sellers. A reasonable amount for the fractional share would be 50%, although it could be significantly more or significantly less. In the case of a 50% fractional share, the example Data Seller would receive compensation in the amount if 0.5 x Comp Credit.

COMPBANK Table:

The COMPBANK database table stores a record of: 1) each purchase of Comp Credits by a Data Buyer from the System Operator; 2) each Invoice issued by the System Operator in exchange to a Comp Credit purchase; 3) each payment of an Invoice and reduction in Invoice balance, 4) each sale of data and analyses to a Data Buyer in exchange for Comp Credits; 5) each usage of data from a Data Seller for the calculation of data and analyses purchased by a Data Buyer; 6) each payment of Comp Credits to a Data Seller for use of the Data Seller's data for calculation of data and analyses purchased by a Data Buyer; 7) each purchase, sale, or transfer of Comp Credits between and amongst Data Buyers and Data Sellers. The COMPBANK Table design is shown in Table 2 below.

TABLE 2
COMPBANK

| Column | Data Type | Allow Nulls |
|---|---|---|
| TRANSACTION_NUM | bigint | Unchecked |
| CLIENTNAME | nvarchar(60) | Unchecked |
| COUNTERPARTY | nvarchar(60) | Unchecked |
| TRANSACTION_TIMESTAMP | datetime2(7) | Unchecked |
| COMPS_TRADE_NUM | float | Unchecked |
| COMPS_TRADE_TRANSFERABLE_NUM | float | Unchecked |
| INVOICE_AMTDUE_INCREASE | money | Unchecked |
| COMPS_BALANCE | float | Unchecked |
| COMPS_BALANCE_TRANSFERABLE | float | Unchecked |
| INVOICE_AMTDUE_PRIN | money | Unchecked |
| INVOICE_AMTDUE_INT | money | Unchecked |
| CASH_TRANSFER | money | Unchecked |
| CASH_TRANSFER_FEE | money | Checked |
| COMPS_TRADE_ORDER_NUM | bigint | Checked |
| COMPS_TRADE_PRICE | float | Checked |
| MFC_DATASALE_TO_CLIENT | bit | Checked |
| MFC_DATABUY_FROM_CLIENT | bit | Checked |
| MFC_DATASALE_MESSAGE | nvarchar(MAX) | Checked |
| COUNTERPARTY_DATASHARE_TO_CLIENT | bit | Checked |
| COUNTERPARTY_DATASHARE_FROM_CLIENT | bit | Checked |
| COUNTERPARTY_DATASHARE_MESSAGE | nvarchar(MAX) | Checked |
| INVOICE_PAYMENT | bit | Checked |
| INVOICE_CHARGE | bit | Checked |
| INVOICE_PAYMENT_OR_CHARGE_MEMO | nvarchar(MAX) | Checked |
| STARTDATE | datetime2(7) | Checked |
| ENDDATE | datetime2(7) | Checked |
| PROPERTYNAME | nvarchar(255) | Checked |
| PROPERTYADDRESS | nvarchar(255) | Checked |
| PROPERTYCITY | nvarchar(255) | Checked |
| PROPERTYSTATE | nvarchar(10) | Checked |
| PROPERTYZIPCODE | bigint | Checked |
| LATITUDE | float | Checked |
| LONGITUDE | float | Checked |
| PROP_COMP_ALGO_DEMO_AVM_STATS | nvarchar(25) | Checked |
| COMP_EXID_PLID_PRID | nvarchar(255) | Checked |
| COMP_PROPERTYNAME | nvarchar(255) | Checked |
| COMP_PROPERTYADDRESS | nvarchar(255) | Checked |
| COMP_PROPERTYCITY | nvarchar(255) | Checked |
| COMP_PROPERTYSTATE | nvarchar(10) | Checked |
| COMP_PROPERTYZIPCODE | bigint | Checked |
| METROSTATS_MDRA | nvarchar(255) | Checked |
| METROSTATS_SUBTYPE | nvarchar(50) | Checked |
| METROSTATS_NUM_PROPS | bigint | Checked |
| EXATRANSACTIONID | nvarchar(50) | Checked |
| EXATRANSACTIONID_NUMACTIVELOANS | int | Checked |

Referencing the column names in Table 2 above, rows are inserted and fields are populated as follows:

When a Data Buyer purchases Comp Credits from the System Operator, a new row is inserted with specified fields populated: Data Buyer name (CLIENTNAME); the amount of Comp Credits purchased (COMPS_TRADE_NUM); the Comp Credits purchase price (COMPS_TRADE_PRICE); the amount of Comp Credits owned by the Data Buyer including the newly purchased Comp Credits (COMPS_BALANCE); the Data Buyer's outstanding invoice balance due including the current purchase, prior purchases, and accrued finance charges (INVOICE_AMTDUE_PRIN+INVOICE_AMTDUE_INT).

When a Data Buyer pays down his Invoice Balance, a new row is inserted with the outstanding invoice balance reduced by the invoice payment amount (INVOICE_PAYMENT).

When a Data Buyer buys or sells Comp Credits with another Data Buyer or Data Seller (a “counterparty”), a row for the buyer is inserted with the COUNTERPARTY field being the seller's CLIENTNAME and a row for the seller is inserted with the COUNTERPARTY field being the buyer's CLIENTNAME.

When a Data Buyer uses Comp Credits to purchase data and analyses, a new row is inserted into the COMPBANK table corresponding to the Data Buyer who purchased the data and analyses, as well as rows inserted for each of the Data Sellers who provided data which is used to calculate the given data and analyses purchased.

Fields populated for the row corresponding to the Data Buyer who purchased the data and analyses include: Data Buyer Name (CLIENTNAME); MFC_DATASALE_TO_DATA_BUYER is populated with the 1=TRUE; the amount of the Comp Credits paid to the System Operator (COMPS_TRADE_NUM) is populated with a negative value corresponding to a reduction in the amount of Comp Credits owned by the Data Buyer; the amount of Comp Credits owned by the Data Buyer after deduction for those used to purchase the specified data and analyses (COMPS_BALANCE); a specification of the type of data and analyses purchased (COMP_PROP_ALGO_DEMO_AVM_STATS); fields which describe the specific data and analyses purchased:
a. the Subject Property that is being analyzed (PROPERTYNAME, PROPERTYADDRESS, PROPERTYCITY, PROPERTYSTATE, PROPERTYZIPCODE);
b. Individual Comp identifiers (COMP_EXID_PLID_PRID, COMP_PROPERTYNAME, COMP_PROPERTYADDRESS, COMP_PROPERTYCITY, COMP_PROPERTYSTATE, COMP_PROPERTYZIPCODE);
c. Specification of observation sets (METROSTATS_MDRA, METROSTATS_SUBTYPE, METROSTATS_NUMPROPS);
d. Specification of a CMBS deal which is analyzed (EXATRANSACTIONID, EXATRANSACTIONID_NUMACTIVELOANS).

Rows inserted for each of the Data Sellers who provided data used to calculate the given data and analyses are mirror images of the fields populated for the row inserted corresponding the Data Buyer who purchased the data and analyses: for the row corresponding to a given Data Seller the CLIENTNAME field is populated with the name of the Data Seller; MFC_DATABUY_FROM_DATA BUYER is populated with the 1=TRUE; the amount of the Comp Credits paid by the System Operator (COMPS_TRADE_NUM) to the Data Seller for data used to calculate the given data and analyses is populated with a positive value corresponding to an increase in the amount of Comp Credits owned by the Data Seller; the amount of Comp Credits owned by the Data Seller (COMPS_BALANCE) after the increase for those paid to compensate the Data Seller for his prorate contribution to data used to calculate the specified data and analyses purchased by the Data Buyer. The specification of the data type and the fields describing the specific data and analyses are the same as for the row inserted corresponding to the Data Buyer.

Distributed Ledger:

The COMPBANK table provides a ledger of all Comp Credits issued, bought, sold, transferred, or redeemed in exchange for data. The ledger may be maintained either on a centralized server or distributed on multiple servers using a blockchain technology. Saving the ledger on distributed servers provides an immutable record of Comp Credits issued, bought, sold, and redeemed for data and analyses. This provides a framework for Comp Credits trading as a cryptocurrency.

What is claimed is:

1. A method, comprising:
receiving input data from a plurality of Data Sellers;
selling tokens to a plurality of Data Buyers;
receiving tokens from a first Data Buyer in exchange for providing data and analyses calculated from input data received from one or more Data Sellers;
paying tokens to the each Data Seller whose data was used to calculate the data and analyses provided to the first Data Buyer; and
trading tokens between token buyers and token sellers

2. The method of claim 1 where token buyers and tokens sellers may be either Data Buyers or Data Sellers.

3. The method of claim 2 where the total amount of tokens paid to all Data Sellers is less than 100% of the total amount of tokens received from the first Data Buyer.

4. The method of claim 3 where the amount of tokens paid to each Data Seller is determined by the amount of data provided by the each Data Seller that is used to calculate the data and analyses provided to the first Data Buyer in comparison to the total amount of data provided by all Data Sellers that is used to calculate the data and analyses provided to the first Data Buyer.

5. The method of claim 1 where a record of all exchanges of tokens and data is saved on a ledger or database table.

6. The method of claim 4 where a copy of the ledger or database table is saved to a plurality of computers.

7. The method of claim 5 where the token is a cryptocurrency.

8. The method of claim 1 where the system operator sells tokens in exchange for invoices to pay for said tokens.

9. The method claim 7 where trading tokens is transacted by increasing a token buyer's outstanding invoice balance and decreasing a token seller's outstanding invoice balance.
